(19) United States
(12) Patent Application Publication
(10) Pub. No.: US 2011/0185544 A1
(43) Pub. Date: Aug. 4, 2011

(54) Fastener for Electric Cables or the Like, in Particular in an Automobile

(75) Inventor: Laurent Torlay, Angers (FR)

(73) Assignee: APLIX, Paris (FR)

(21) Appl. No.: 13/119,809

(22) PCT Filed: Jul. 22, 2009
(86) PCT No.: PCT/FR2009/000909

§ 371 Date: Mar. 18, 2011

(30) Foreign Application Priority Data
Sep. 22, 2008 (FR) 0805182

(51) Int. Cl. H02G 3/30; H02G 3/02

(52) U.S. Cl. 24/451; 24/442

(57) ABSTRACT

A fastener-forming element, designed to fasten at least one oblong element, e.g. at least one electric cable, to a second element, e.g. a panel or a partition, e.g. of a motor vehicle, is characterized in that it is constituted by a strip having two opposite faces, male elements in particular in the form of hooks, projecting from one of the two faces, said male elements being designed to co-operate either with female elements, in particular loops, stemming from the second element (when a male-female self-fastener is formed), or with other male elements stemming from the second element (when a male-male self-fastener is formed), and in that the strip is rolled up helically, so that said one of the two faces from which the male elements stem is on the outside of the fastener-forming element, the strip thus defining an inside space designed to receive the at least one element of oblong shape.

The present invention relates to a fastener-forming element designed to fasten at least one element of oblong shape, in particular an electric cable, to another element, in particular a panel or a partition in a motor vehicle, e.g. a motor vehicle roof. The present invention also relates to an assembly constituted by at least one first oblong element, e.g. at least one electric cable, by a second element, e.g. a panel or a partition, e.g. of a motor vehicle, and by a fastener-forming element of this type.

In a motor vehicle, for example, numerous electric cables are installed for conveying electrical power or data, their number increasing as the electronic control systems for motor vehicles become increasingly sophisticated. It is desired to have a fastener that makes it possible both to hold a plurality of cables together and also to fasten them to a wall of the motor vehicle, in a manner that is as simple as possible, in particular once the cables have already been installed, without it being necessary to thread the fastener over one of the ends of the cables.

An object of the present invention is thus to provide a fastener-forming element that offers the above-mentioned advantages.

In a first aspect of the invention, the fastener-forming element, designed to fasten at least one oblong element, e.g. at least one electric cable, to a second element, e.g. a panel or a partition, e.g. of a motor vehicle, is characterized in that it is constituted by a strip having two opposite faces, male elements in particular in the form of hooks, projecting from one of the two faces, said male elements being designed to co-operate either with female elements, in particular loops, stemming from the second element (when a male-female self-fastener is formed), or with other male elements stemming from the second element (when a male-male self-fastener is formed), and in that the strip is rolled up helically, so that said one of the two faces from which the male elements stem is on the outside of the fastener-forming element, the strip thus defining an inside space designed to receive the at least one element of oblong shape.

In another aspect of the invention, the fastener-forming element, designed to fasten at least one oblong element, e.g. at least one electric cable, to a second element, e.g. a panel or a partition, e.g. of a motor vehicle, is characterized in that it is constituted by a strip having two opposite faces, female elements in particular in the form of loops, projecting from one of the two faces, said female elements being designed to co-operate with male elements stemming from the second element, and in that the strip is rolled up helically, so that said one of the two faces from which the female elements stem is on the outside of the fastener-forming element, the strip thus defining an inside space designed to receive the at least one element of oblong shape.

In this way, by providing a fastener that is of helical shape, that has a male portion or a female portion of a male-female self-fastener that co-operates with the female or male element of the other article to which it is to be fastened, a fastener is procured that is very simple to use, and that, in particular, can hold together a plurality of cables inside the fastener so as to fasten them to the second element in a simple manner, and in particular in a removable manner and, in addition, that can be put into place without having to thread the fastener over one of the ends of the cables, which would be necessary if the fastener were in the usual closed annular shape. The fact that the fastener is of helical shape makes it possible to insert the cables directly into it at the place where the cables are to be fastened, merely by turning the fastener screw-like around the cables, once said cables have been inserted between two turns of the helix.

In the context of the invention, the term “hook” means any element having a hooking portion that can hook into a loop so that fastening is achieved between the hook and the loop in at least one hooking direction. And any such “element” described in this Application as a “hook” may, for example, also be a barb, a mushroom hook, a double hook, or some other analogous element.

Preferably, the fastener-forming element is made of a thermoplastic material, e.g. of polyethylene, of polypropylene or the like.

In a preferred embodiment of the invention, the fastener-forming element is constituted by a first layer of a thermoplastic material and by a second layer in the form of sheet having hooks that has been fastened to the first layer of thermoplastic material, in particular by adhesive bonding, heat sealing, ultrasound welding or the like.

In another preferred embodiment of the invention, the fastener-forming element is constituted by a first layer of a thermoplastic material and by a textile element having loops in the form of a layer of non-woven or woven fabric having loops, such as a knitted fabric or a woven fabric, in particular made using a loom or a knitting machine having three bars for three threads, respectively the warp, the weft, and the loop. In particular, the textile element is adhesively bonded or welded (heat sealing, ultrasound welding, and the like) to the first layer.

In yet another preferred embodiment of the invention, the fastener-forming element is constituted by a sheet or strip made of a thermoplastic material and from which hooks stem integrally, the sheet having hooks being formed, in particular, by extrusion.

In a preferred embodiment of the invention, the fastener-forming element is obtained by starting from a flexible hollow tube made of a thermoplastic material around which a sheet having hooks or a textile element having loops has been fastened by adhesive bonding, welding, in particular heat sealing or ultrasound welding, or the like, and by cutting the resulting assembly to form the helical fastener.

The present invention also provides an assembly constituted by a first element of oblong shape, e.g. an electric cable, by a second element to which it is desired to fasten the first element, e.g. a panel or a partition, in particular an element of plane shape, and by a fastener-forming element of the invention, the second element having the male or female portion that co-operates with the female or male portion stemming from the fastener-forming element to procure male-male or male-female self-fastening.

The present invention also provides a motor vehicle including an assembly of the invention.

An embodiment of the invention is described below merely by way of example, with reference to the accompanying drawings, in which:

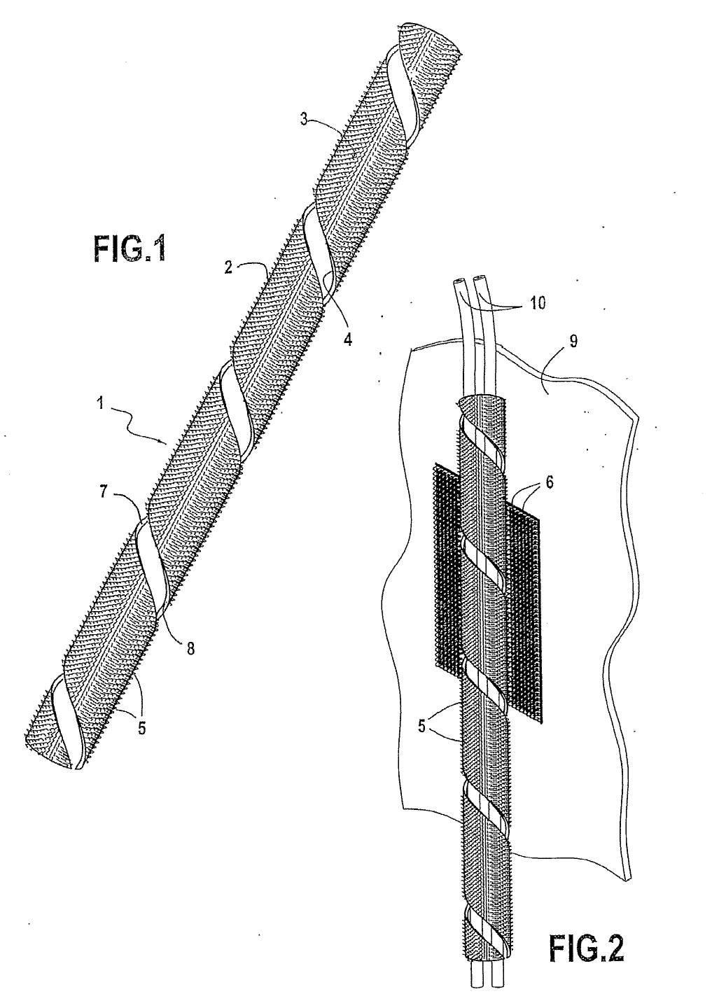

FIG. 1 is a perspective view of a fastener-forming element of the invention; and

FIG. 2 is a diagram of an example of an assembly of the invention including the fastener-forming element of FIG. 1.

FIG. 1 shows a fastener 1 of the invention. The fastener 1 is in the form of a strip 2 that has been rolled up helically. The strip 2 has an outside face 3 and an inside face 4. A multitude of hooks 5 that stem integrally from the strip 2 project from the outside face 3. The hooks 5 are designed to co-operate with loops 6 that stem from a wall 9 in the form of a plate. The loops 6 may, in particular, be made in the form of a knitted or a woven or a non-woven fabric having loops, which fabric has, in particular, been adhesively bonded or heat sealed to the plate 9.

The fastener 1 comprises an inner layer 8 that is made of a flexible thermoplastic material and an outer layer 7 that is also made of a thermoplastic material and that is constituted by the strip 2 and by the hooks 5 stemming integrally therefrom. The two layers 7 and 8 are bonded together by adhesive bonding, heat sealing, ultrasound welding, or the like.

In use, as shown in FIG. 2, a plurality of cables 10 passes through the inside of the fastener 1 and are held against the plate 9 by the loops 6 co-operating with the hooks 5.

In another embodiment that is not shown in the figures but that is entirely equivalent, it is possible to replace the layer 7 having hooks with a knitted or a woven or a non-woven fabric having loops that is adhesively bonded to the layer 8, the loops thus projecting from the outside face of the fastener-forming element, while a sheet having hooks and corresponding to the sheet having hooks of FIG. 1 is fastened to the plate 9. In such an embodiment, the cables are fastened to the plate in the same manner by means of the fastener.

However, the embodiment in which provision is made for hooks to stem from the fastener and for loops to stem from the plate is simpler to fabricate, and in particular it is possible to obtain large areas of knitted, non-woven, or woven fabrics merely by adhesively bonding them to plates 9. It is also possible, instead of the loops, to provide hooks for male-to-male self-fastening, i.e. hook-in-hook, in which case, the plate 9 is also provided with hooks instead of loops, its hooks co-operating with the hooks that stem from the surface 3 of the fastener.

The plate 9, which may be plane, is secured to a motor vehicle, and, in particular, is an integral part thereof. In particular, it may be a roof or a door panel.

The cable may convey electrical power or data. It could also be replaced by pipes for conveying fluids, such as water, air, or the like, or by optical fiber cables.

The thickness of the fastener is chosen, as a function of its material, to impart a certain amount of flexibility to it, enabling it to be deformed so as to obtain its final helical shape, but nevertheless to be sufficiently rigid for it to keep its helical shape intrinsically, in particular for it to be strong enough to support one or more cables and to keep them fastened to the wall.

For example, for a highly preferred application to the automobile industry, the thickness of the strip may, in particular lie in the range 1.5 millimeters (mm) to 4 mm. In addition, the pitch of its helix (distance between two successive turns measured in the direction of the longitudinal axis of the helix) may lie in the range 10 mm to 30 mm. The height of the hooks may lie in the range 0.3 mm to 1.5 mm.

The length of the fastener (as measured along the longitudinal axis) may lie in the range 50 mm to 200 mm, while the diameter of a turn of the fastener may lie in the range 1.5 mm to 20 mm.

In addition, the strip having hooks may be formed, prior to it being deformed helically or prior to it being bonded to a backing layer before the resulting lamination is deformed helically, by an extrusion method, in particular as described in U.S. Pat. No. 4,056,593 to Repla.

The loops may be constituted by a conventional knitted fabric having two or three threads, namely the warp and/or the weft and the loop, or by a non-woven fabric having loops, such fabrics being well known in the field of self-fasteners, in particular in the field of diaper fasteners.

The hooks project from the fastener while being distributed uniformly at its surface, in particular in a regular array of hooks per square centimeter.

1. A fastener-forming element, designed to fasten at least one oblong element, e.g. at least one electric cable, to a second element, e.g. a panel or a partition, e.g. of a motor vehicle, wherein said fastener-forming element is constituted by a strip having two opposite faces, male elements in particular in the form of hooks, projecting from one of the two faces, said male elements being designed to co-operate either with female elements, in particular loops, stemming from the second element (when a male-female self-fastener is formed), or with other male elements stemming from the second element (when a male-male self-fastener is formed), and wherein the strip is rolled up helically, so that said one of the two faces from which the male elements stem is on the outside of the fastener-forming element, the strip thus defining an inside space designed to receive the at least one element of oblong shape.

2. A fastener-forming element, designed to fasten at least one oblong element, e.g. at least one electric cable, to a second element, e.g. a panel or a partition, e.g. of a motor vehicle, wherein said fastener-forming element is constituted by a strip having two opposite faces, female elements in particular in the form of loops, projecting from one of the two faces, said female elements being designed to co-operate with male elements stemming from the second element, and wherein the strip is rolled up helically, so that said one of the two faces from which the female elements stein is on the outside of the fastener-forming element, the strip thus defining an inside space designed to receive the at least one element of oblong shape.

3. The fastener-forming element according to claim 1, made of a thermoplastic material, e.g. of polyethylene, of polypropylene or the like.

4. The fastener-forming element according to claim 1, constituted by a first layer of a thermoplastic material and by a second layer in the form of a sheet having hooks that has been fastened to the first layer of thermoplastic material, in particular by adhesive bonding, heat sealing, ultrasound welding or the like.

5. The fastener-forming element according to claim 2, made of a thermoplastic material, e.g. of polyethylene, of polypropylene or the like.

6. The fastener-forming element according to claim 2, constituted by a first layer of a thermoplastic material and by a textile element having loops in the form of a layer of non-woven or woven fabric having loops, such as a knitted fabric or a woven fabric, in particular made using a loom or a knitting machine having three bars for three threads, respectively the warp, the weft, and the loop.

7. The fastener-forming element according to claim 1, obtained by starting from a flexible hollow tube made of a thermoplastic material around which a sheet having hooks or a textile element having loops has been fastened by adhesive bonding, welding, in particular heat sealing or ultrasound welding, or the like, and by cutting the resulting assembly to form the helical fastener.

8. The fastener-forming element according to claim 1, constituted by a sheet or strip made of a thermoplastic material and from which hooks stem integrally, the sheet having hooks being formed, in particular, by extrusion.

9. An assembly constituted by a first element of oblong shape, e.g. an electric cable, by a second element to which it is desired to fasten the first element, e.g. a panel or a partition, in particular an element of plane shape, and by a fastener-forming element according to claim 1, the second element having the male or female portion that co-operates with the female or male portion stemming from the fastener-forming element to procure male-male or male-female self-fastening.

10. A motor vehicle including an assembly according to claim 9.

11. The fastener-forming element according to claim 2, obtained by starting from a flexible hollow tube made of a thermoplastic material around which a sheet having hooks or a textile element having loops has been fastened by adhesive bonding, welding, in particular heat sealing or ultrasound welding, or the like, and by cutting the resulting assembly to form the helical fastener.

12. An assembly constituted by a first element of oblong shape, e.g. an electric cable, by a second element to which it is desired to fasten the first element, e.g. a panel or a partition, in particular an element of plane shape, and by a fastener-forming element according to claim 2, the second element having the male or female portion that co-operates with the female or male portion stemming from the fastener-forming element to procure male-male or male-female self-fastening.

13. A motor vehicle including an assembly according to claim 12.
